(19) United States
(12) Patent Application Publication
(10) Pub. No.: US 2009/0322949 A1
(43) Pub. Date: Dec. 31, 2009

(54) VIDEO SIGNAL PROCESSOR AND VIDEO SIGNAL PROCESSING METHOD

(75) Inventor: Shinsuke Masuda, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/392,863

(22) Filed: Feb. 25, 2009

(30) Foreign Application Priority Data
Jun. 30, 2008 (JP) 2008-170428

(51) Int. Cl. H04N 5/14; H04N 3/27

(52) U.S. Cl. 348/571; 348/554; 348/E03.049; 348/E05.062

(57) ABSTRACT

According to one embodiment, a video signal processor includes an input module which receives a second video signal including control information for performing various specification about acquisition and display of a first video signal, an obtaining module which obtains the first video signal based on the specification of the control information detected from the second video signal and performs the processing about the display, and a processing module which superimposes the first video signal on the second video signal to display the both on the same screen at the same time.

### CROSS-REFERENCE TO RELATED APPLICATIONS

This application is based upon and claims the benefit of priority from Japanese Patent Application No. 2008-170428, filed Jun. 30, 2008, the entire contents of which are incorporated herein by reference.

### BACKGROUND

1. Field

One embodiment of the invention relates to a video signal processor and a video signal processing method of receiving a plurality of video signals to be used for multi-screen display.

2. Description of the Related Art

As is well known, recently, a digital television broadcasting receiver including a terminal (D-Sub: subminiature-D) to be connected to a PC (personal computer) has been prevalent, and hence it can receive video signals of high resolution from the PC and display a video.

There appears such a digital television broadcasting receiver that is provided with a so-called double screen display function for simultaneously displaying the video signal supplied from the PC and the video signal restored from the received television broadcast signal.

Generally, as the double screen display function, there are mainly a first form of dividing the whole screen into two in a horizontal direction and displaying mutually different videos in the respective regions, and a second form (PIP: Picture In Picture) of displaying one video on the whole screen and displaying another video in a small size screen in a way of superimposing it on the whole screen.

In the case of the first form, since the size of each displayed video is really small and the quality is declined, it is difficult to visually recognize it. Since a special device and operation are required to change the size and the display position of the video displayed on the child screen in the second form, the handling becomes troublesome.

Jpn. Pat. Appln. KOKAI Publication No. 2001-157135 discloses a television receiver which informs the reception in a user's desired display mode [including PIP display mode, OSD (On Screen Display) mode, and whole screen display mode] in the case of receiving a signal through an external input, when the video from an internal tuner is displayed on the screen.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block structural diagram, showing an embodiment of the invention, for use in describing the outline of a video signal processing system;

FIG. 2 is a block structural diagram for use in describing a signal processing series of a digital television broadcasting receiver forming the video signal processing system in the embodiment;

FIG. 3 is a view for use in describing an example of the video displayed on the digital television broadcasting receiver based on a video signal supplied from the PC in the embodiment;

FIG. 4 is a view for use in describing an example of displaying the video supplied from the PC and the received video of the television broadcast at the same time on the digital television broadcasting receiver in the embodiment; and

FIG. 5 is a flow chart for use in describing the processing operation of a pattern recognition processing module included in the digital television broadcasting receiver in the embodiment.

### DETAILED DESCRIPTION

Various embodiments according to the invention will be described hereinafter with reference to the accompanying drawings. In general, according to one embodiment of the invention, a video signal processor includes an input module which receives a second video signal including control information for performing various specification about acquisition and display of a first video signal, an obtaining module which obtains the first video signal based on the specification of the control information detected from the second video signal and performs the processing about the display, and a processing module which superimposes the first video signal on the second video signal to display the both on the same screen at the same time.

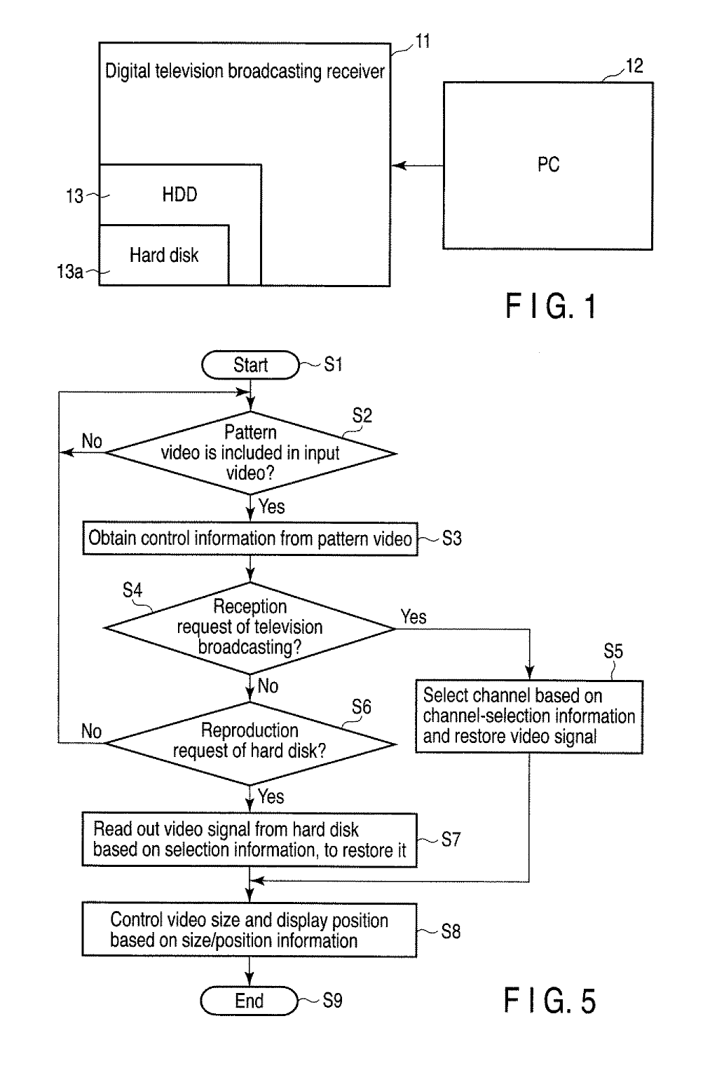

FIG. 1 shows the outline of a video signal processing system described in the embodiment. In the video signal processing system, a video signal supplied from a PC 12 as a video output device can be transmitted to a digital television broadcasting receiver 11 as a video signal processor, for example, through a digital interface such as a LAN (Local Area Network).

The digital television broadcasting receiver 11 can be adopted to display the video signal of high resolution supplied from the PC 12 on a video displayer described later.

Further, the digital television broadcasting receiver 11 can be adopted to restore a video signal from a received television broadcast signal and display the video. The digital television broadcasting receiver 11 can be adopted to restore the video signal from the received television broadcast signal and record it in a hard disk 13a by a built-in HDD (Hard Disk Drive) 13. Further, the digital television broadcasting receiver 11 can be adopted to reproduce the video signal recorded in the hard disk 13a, through the HDD 13 and display the video.

Although the details will be described later, the digital television broadcasting receiver 11 can be adopted to display the video signal supplied from the PC 12 and the video signal restored from the received television broadcast signal on a double screen in the video displayer. The digital television broadcasting receiver 11 can be adopted to display the video signal supplied from the PC 12 and the video signal recorded in the hard disk 13a and reproduced through the HDD 13 on the double screen in the video displayer.

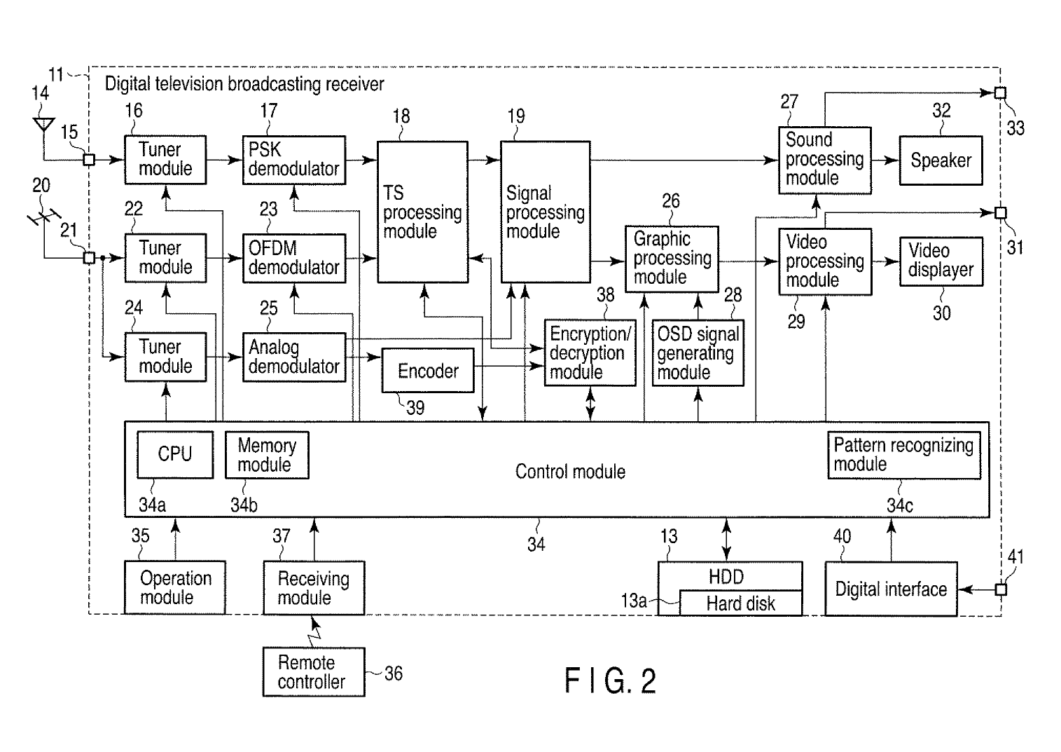

FIG. 2 shows a main flow of signal processing in the digital television broadcasting receiver 11. A satellite digital broadcast signal received by an antenna 14 for BS/CS (Broadcasting Satellite/Communication Satellite) digital broadcasting reception is supplied to a tuner module 16 for satellite digital broadcast through an input terminal 15, where a broadcast signal of a desired channel is selected.

A broadcast signal of the channel selected by the tuner module 16 is supplied to a PSK (Phase Shift Keying) demodulator 17 and the TS (Transport Stream) is demodulated there. After the TS is supplied to a TS processing module 18 and decoded into a digital video signal and a digital sound signal, they are supplied to a signal processing module 19.

A terrestrial digital television broadcast signal received by an antenna 20 for terrestrial broadcasting reception is supplied to a tuner module 22 for terrestrial digital broadcast through an input terminal 21, where a broadcast signal of a desired channel is selected.

The broadcast signal selected by the tuner module 22 is supplied to an OFDM (Orthogonal Frequency Division Multiplexing) demodulator 23 and the TS is demodulated. After the TS is supplied to the TS processing module 18 and decoded into a digital video signal and a digital sound signal, they are supplied to the signal processing module 19.

A terrestrial analog television broadcast signal received by the antenna 20 for terrestrial broadcasting reception is supplied to a tuner module 24 for terrestrial analog broadcast through the input terminal 21, where a broadcast signal of a desired channel is selected. After the broadcast signal selected by the tuner module 24 is supplied to an analog demodulator 25 and demodulated into an analog video signal and an analog sound signal, they are supplied to the signal processing module 19.

The signal processing module 19 performs predetermined digital signal processing on the digital video signal and the digital sound signal supplied from the TS processing module 18 and outputs the signals to a graphic processing module 26 and a sound processing module 27. After the signal processing module 19 converts the analog video signal and the analog sound signal supplied from the analog demodulator 25 into digital signals and performs the predetermined digital signal processing on the digital video signal and the digital sound signal, it outputs the above signals to the graphic processing module 26 and the sound processing module 27.

The graphic processing module 26 has a function of superimposing an OSD signal generated in an OSD signal generating module 28 on the digital video signal supplied from the signal processing module 19 and outputting it. The graphic processing module 26 can selectively output the output video signal of the signal processing module 19 and the output OSD signal of the OSD signal generating module 28 and output the both to form each half screen.

The digital video signal output from the graphic processing module 26 is supplied to a video processing module 29. The video processing module 29 converts the received digital video signal into an analog video signal of format displayable on a video displayer 30 and adjusts the display size and the display position as necessary, and then, outputs the above signal to the video displayer 30 to display the video and leads the signal to the outside through an output terminal 31.

The sound processing module 27 converts the received digital sound signal into an analog sound signal of format which can be reproduced by a speaker 32, and then, outputs the signal to the speaker 32 to reproduce the sound and leads the signal to the outside through an output terminal 33.

In the digital television broadcasting receiver 11, a control module 34 controls all the operations including the above-mentioned various receiving operations collectively. The control module 34 includes a CPU (Central Processing Unit) 34a and, upon reception of the operation information from an operation module 35 set in the digital television broadcasting receiver 11 itself or the operation information transmitted from a remote controller 36 and received by a receiving module 37, controls each module so that it may reflect the contents of the operation.

In this case, the control module 34 uses a memory module 34b. The memory module 34b mainly has a ROM (read only memory) which stores a control program carried out by the CPU 34a, a RAM (random access memory) for providing a working area to the CPU 34a, and a non-volatile memory which stores various setting information and control information.

The HDD 13 is connected to the control module 34. Based on a user's operation of the operation module 35 or the remote controller 36, or an instruction of the control program carried out by the CPU 34a, the control module 34 can control the digital signal of MPEG (moving picture experts group) 2-TS obtained by the TS processing module 18 to be encrypted by an encryption/decryption module 38, then to be supplied to the HDD 13, and to be recorded in the hard disk 13a.

Based on a user's operation of the operation module 35 or the remote controller 36, or an instruction of the control program carried out by the CPU 34a, the control module 34 can control the analog video signal and the analog sound signal obtained by the analog demodulator 25 to be converted into MPEG2-TS by the encoder 36, encrypted by the encryption/decryption module 38, then to be supplied to the HDD 13, and to be recorded in the hard disk 13.

Based on a user's operation of the operation module 35 or the remote controller 36, or an instruction of the control program carried out by the CPU 34a, the control module 34 can control the operation so that the MPEG2-TS is read out from the hard disk 13a through the HDD 13, decrypted by the encryption/decryption module 38 and then supplied to the TS processing module 18, thereby using the above signal for the video display and the sound reproduction.

Further, a digital interface 40 is connected to the control module 34. The digital interface 40 has a function of receiving the video signal supplied from the PC 12 through an input terminal 41. The control module 34 supplies the output video signal received from the PC 12 through the digital interface 40 to the video processing module 29, thereby using the above signal for displaying a video on the video displayer 30.

The control module 34 includes a pattern recognizing module 34c. The pattern recognizing module 34c detects whether or not the video signal includes, for example, a specific pattern video including control information formed of a character string when the output video signal from the PC 12 is used for video display on the video displayer 30.

The pattern video includes the control information including the channel-selection information for specifying a channel to receive a television broadcast and the size and position information for specifying the size and the position of the display screen when displaying the video signal restored from the television broadcast in the channel specified by the channel-selection information on the video displayer 30.

When the video signal supplied from the PC 12 includes the specific pattern video, the pattern recognizing module 34c controls the digital television broadcasting receiver 11 to receive the television broadcast in a channel specified according to the channel-selection information, restore the video signal, and perform the scaling processing and the display position processing on the restored video signal so that it may be displayed on the video displayer 30 in a size at a position based on the size/position information.

Then, the video processing module 29 superimposes the video signal of the television broadcast with the scaling processing and the display position processing performed there on the video signal supplied from the PC 12. Therefore, the video displayer 30 displays the video supplied from the PC 12 and the video of the received television broadcast at the same time.

In this case, based on the pattern video included in the video supplied from the PC 12, a receiving channel, display size, and display position, in the video of the television broadcast, are automatically set without using any special device and trouble some operation. Therefore, a user can handle it conveniently.

There is the case where the pattern video includes the control information including the selection information for specifying the video signal to be read out from the hard disk 13a and the size and position information for specifying the size and the position of the display screen when restoring the video signal specified according to the selection information and displaying the above signal on the video displayer 30.

In this case, the pattern recognizing module 34c controls the digital television broadcasting receiver 11 to read out the video signal specified according to the selection information from the hard disk 13a, restore the video signal, and perform the scaling processing and the display position processing on the restored video signal so that it may be displayed on the video displayer 30 in a size at a position based on the size and position information.

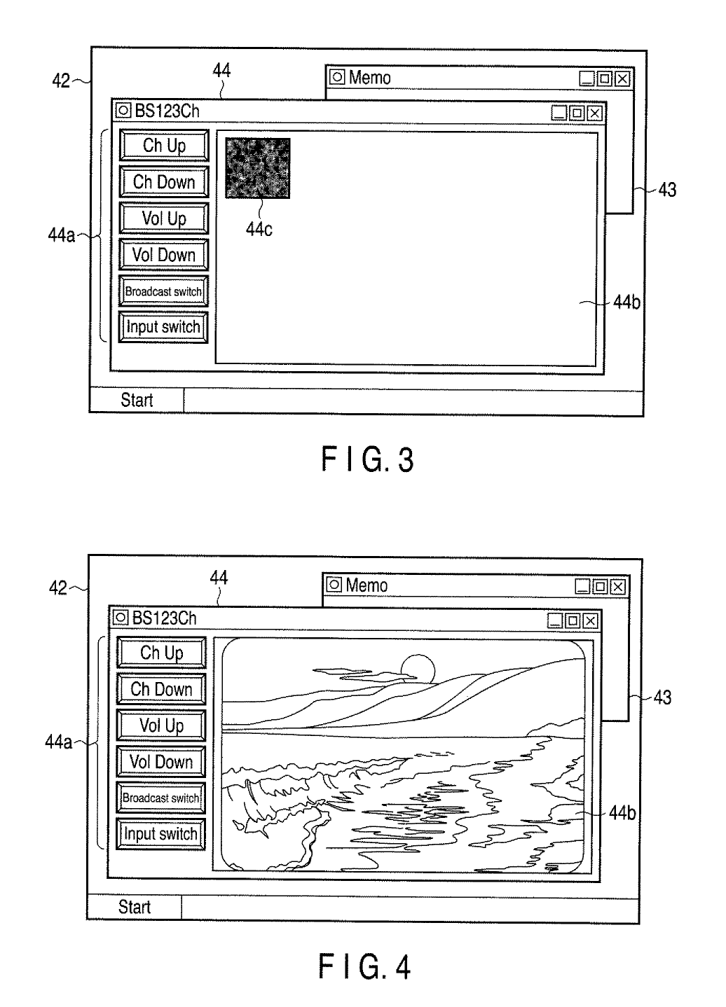

Hereinafter, a detailed description will be made in the case of simultaneously displaying the video signal supplied from the PC 12 and the video signal of the television broadcast received based on the specific pattern video included in the video signal on the video displayer 30. FIG. 3 shows an example of video 42 displayed on the video displayer 30 based on the video signal supplied from the PC 12.

In the video 42, there are shown an application window 43 working as a memo and an application window 44 working for television broadcasting reception.

In the application window 44, icons 44a for various operations for receiving the predetermined television broadcast in the digital television broadcasting receiver 11 are displayed and a pattern video 44c is displayed in a display region 44b for displaying the video of the received television broadcast.

The pattern video 44c is generated, for example, by a QR (Quick Response) code, and as mentioned above, includes the control information formed by the channel-selection information, the selection information, and the size and position information. The example shown in FIG. 3 includes such control information having the channel-selection information and the size and position information that the television broadcast of BS123 Ch is received, the video signal is restored, and that it is displayed in the display region 44b within the application window 44 as shown in FIG. 4.

In the case where a user operates the operation icons 44a to change the receiving channel of television broadcast, the contents of the channel-selection information in the control information within the pattern video 44c change accordingly. When a user changes the size and the display position of the application window 44, the contents of the size and position information within the control information of the pattern video 44c change accordingly.

Therefore, as long as the pattern recognizing module 34c detects the control information within the pattern video 44c periodically, when the receiving channel, the display size, and the display position are changed according to a user's operation and when the control information of the pattern video included in the video signal supplied from the PC 12 is changed, the video display of the television broadcast can be adapted to these changes.

When the video signal supplied from the PC 12 and the video signal which is read out from the hard disk 13a and restored based on the specific pattern video included in the video signal are displayed on the video displayer 30 at the same time, the application window working for reproduction in the hard disk 13a is displayed and the pattern video having the control information including the selection information and the size and position information is displayed in its display region.

FIG. 5 shows a flow chart of the processing operations of the pattern recognizing module 34c. When the processing is started (Step S1), the pattern recognizing module 34c checks whether or not the specific pattern video is included in the video signal supplied through the digital interface 40 in Step S2.

When it is judged that the specific pattern video is included (YES), after the pattern recognizing module 34c obtains the control information from the pattern video in Step S3, it is judged whether or not the contents of the obtained control information are to request the reception of the television broadcast in Step S4.

When it is judged that the contents of the obtained control information are to request the reception of the television broadcast (YES), the pattern recognizing module 34c controls each module of the digital television broadcasting receiver 11 to select the television broadcast of a channel specified by the channel-selection information included in the obtained control information and restore the video signal in Step S5.

When it is judged that the contents of the control information are not to request the reception of the television broadcast in Step S4 (NO), the pattern recognizing module 34c checks whether or not the contents of the obtained control information are to request the reproduction of the video signal from the hard disk 13a in Step S6.

When it is judged that the contents of the obtained control information are not to request the reproduction of the video signal from the hard disk 13a (NO), the pattern recognizing module 34c is returned to the processing in Step S2.

When it is judged that the contents of the control information are to request the reproduction of the video signal from the hard disk 13a in Step S6 (YES), the pattern recognizing module 34c controls each module of the digital television broadcasting receiver 11 to read out the video signal specified by the selection information included in the obtained control information from the hard disk 13a and restore it, in Step S7.

After Step S5 or Step S7, the pattern recognizing module 34c controls each module of the digital television broadcasting receiver 11 to perform the scaling processing and the display position processing on the restored video signal so that it may be displayed on the video displayer 30 in a size at a position based on the size and position information included in the obtained control information in Step S8, hence to complete the processing (Step S9).

The above-mentioned embodiment has been described in the case where the video obtained from the television broadcast or the hard disk 13a is displayed in the display region 44b of the application window 44 displayed by the PC 12, based on the control information included in the video signal supplied from the PC 12.

It is not limited to this, but when the digital television broadcasting receiver 11 has a function of obtaining a predetermined video signal from the network, if the control information contains specifying information for specifying a predetermined video signal on the network, instead of the channel-selection information and the selection information, it is possible to display the video obtained through the network in the display region 44b of the application window 44 displayed by the PC 12.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A video signal processor comprising:
an input module configured to receive a second video signal which includes control information for performing various kinds of specification about acquisition and display of a first video signal so that the control information is displayed as a pattern video in a displayed video;
an obtaining module configured to detect the control information from the pattern video and perform the processing about acquisition and display of the first video signal based on the detected control information; and
a processing module configured to superimpose the processed first video signal on the second video signal so that both video signals are simultaneously displayed on the same screen.

2. A video signal processor of claim 1, further comprising:
a display module configured to display the first video signal and the second video signal which are superimposed by the processing module, on the same screen at the same time.

3. A video signal processor of claim 1, wherein
the control information includes channel-selection information for specifying a broadcast channel and size/position information for specifying display size and display position of the first video signal broadcasted by the broadcast channel specified according to the channel-selection information, and
the obtaining module is configured to receive the broadcast channel specified according to the channel-selection information, obtain the first video signal, and perform the processing on the obtained first video signal so that the first video signal is displayed in the display size at the display position specified according to the size/position information.

4. A video signal processor of claim 1, wherein
the control information includes selection information for specifying the first video signal recorded in a recording medium and size/position information for specifying display size and display position of the first video signal specified according to the selection information, and
the obtaining module is configured to obtain the first video signal specified according to the selection information from the recording medium and perform the processing on the obtained first video signal so that the first video signal is displayed in the display size at the display position specified according to the size/position information.

5. A video signal processor of claim 1, wherein
the control information includes specifying information for specifying the first video signal on a network and the size/position information for specifying display size and display position of the first video signal specified according to the specifying information, and
the obtaining module is configured to obtain the first video signal specified according to the specifying information through the network and perform the processing on the obtained first video signal so that the first video signal is displayed in the display size at the display position specified according to the size/position information.

6. A video signal processor of claim 1, wherein
the second video signal is output from a computer and permits an application window to be displayed as the displayed video to obtain the first video signal, and
the pattern video is displayed within the application window.

7. A video signal processor of claim 6, wherein
the obtaining module is configured to perform the processing about the display size and the display position on the first video signal obtained based on the specification of the control information in order to display the first video signal in a video display region for the first video signal provided in the application window.

8. A video signal processing method comprising:
receiving a second video signal which includes control information for performing various kinds of specification about acquisition and display of a first video signal so that the control information is displayed as a pattern video in a displayed video;
detecting the control information from the pattern video, obtaining the first video signal based on the detected control information, and performing processing about display; and
superimposing the obtained and processed first video signal on the received second video signal so that both video signals are displayed at the same time on the same screen.
